(19) United States
(12) Patent Application Publication
(10) Pub. No.: US 2004/0247279 A1
(43) Pub. Date: Dec. 9, 2004

(54) Door or access control system

(76) Inventor: Terence Christopher Platt, Binfied Bracknell (GB)

Correspondence Address: R Lewis Gable, Cowan Liebowitz & Latman, 1133 Avenue of the Americas, New York, NY, 10036-6799, US

(21) Appl. No.: 10/485,044

(22) PCT Filed: Jul. 22, 2002
(86) PCT No.: PCT/GB02/03355

(30) Foreign Application Priority Data
Jul. 24, 2001 (GB) 0118020.7

(51) Int. Cl. H04N 9/80

(52) U.S. Cl. 386/12

(57) ABSTRACT

A door or access control system includes an object detector in which a rising or falling edge in an analogue video signal is detected as indicative of an edge of an object in a field of view.

The present invention relates to the field of door or access control. The present invention can be used for example to detect objects (which term includes, for the purposes of this patent application, human beings or animals) obstructing a doorway (such as a lift door), being located close to a doorway or passing through a doorway. However, these examples are not to be understood in a limiting sense, and various other applications of access control are possible.

Various door or access control systems using infrared and radar based sensors are known in the art. In one known example, a sensing device is mounted above the entrance to an automatic door, and is used to detect the presence of a moving object in the approach zone. If such an object is detected, the detection device issues a signal to the door mechanism and the door is opened for access. Doppler shift microwave radar is widely used as it is relatively inexpensive and reliable, but this form of detection is inherently reliant on motion between the radar sensor and the object being sensed. A slow-moving or static object (such as a person collapsed in the doorway) will not be sensed and a secondary protection device is necessary to overcome this weakness, which increases costs and makes installation more burdensome. It is also difficult to sense the direction of motion with a radar based system and hence, in the example of a detection system installed at a door, a positive detection result may be caused by persons passing by, rather than attempting to enter the doorway.

Infrared detectors often are more sophisticated than radar detectors and can both have “static” and “motion” detection sensors, in some cases with direction sensing. However, this tends to complicate the device and can cause unreliability, especially if the set-up procedure is complex.

The present invention aims to enable object detection which does not suffer the above disadvantages.

In a first aspect the present invention provides a door or access control system including an object detector for detecting a rising or falling edge in an analogue video signal as indicative of an edge of an object in the field of view. A commercially available and relatively inexpensive video camera can be used to provide the analogue video signal. Performing the detection of rising or falling edges directly on the analogue video signal can result in a very simple and economical device.

Preferably, the rising or falling edge is detected by differentiating the analogue video signal.

The system is preferably capable of detecting both rising and falling edges.

Preferably, the system further comprises means for storing a representation of the detected edges of the object. This can be useful for keeping a record of detected objects, but it is primarily of interest for detecting motion (and preferably the direction of motion) of detected objects. Hence, preferably, the system further comprises means for detecting temporal changes in the detected edges of the object.

Preferably, the system further comprises means for providing an output indicative of the presence of the object in the field of view.

The system preferably also provides a camera for providing the analogue video signal to the detector.

Preferably, the system further comprises means for displaying a visual representation of the analogue video signal. This can be useful for visually monitoring the field of view, e.g. in intruder detection applications.

Preferably, the system further comprises means for displaying a visual representation of the detected edges of the object. This could be useful for set-up purposes, when e.g. the sensitivity of the system is adjusted. This can be achieved by adjusting a detection threshold and simultaneously monitoring the displayed edges (outline) of an object in the field of view. Most preferably, in particular for set-up purposes, the field of view is monitored simultaneously with the detected edges of the object. Hence preferably, the visual representation of the detected edges of the object is superimposed on the visual representation of the analogue video signal. This can be achieved by superimposing a signal representative of the detected edges of the object on the analogue video signal, and displaying the resulting combined signal on the same screen.

As the video signal provided by the camera may include synchronisation pulses, the system preferably comprises means for removing the synchronisation pulses from the video signal and passing the thus processed signal to the detector. Thus the present invention also provides a door or access control system including a system for detecting an object in a field of view comprising

a camera for providing an analogue video signal including synchronisation pulses;

means for removing the synchronisation pulses from the analogue video signal;

a signal edge detector for detecting rising or falling edges in the processed analogue video signal; and

an output device for producing an output indicative of an edge of an object in the field of view, based on the detection result of the signal edge detector.

The removing means may comprise a synchronisation pulse separator for producing a synchronisation signal from the analogue video signal, the synchronisation signal being representative of the synchronisation pulses; and a synchronisation pulse remover for producing the processed analogue video signal by removing the synchronisation pulses from the analogue video signal, using the synchronisation signal.

Preferably, the detector comprises an inverter for producing an inverted processed analogue video signal. Edge detection can then be carried out on both the inverted and the non-inverted signal. This may simplify the detection of both rising and falling edges.

Preferably, the system comprises means for obtaining a pixel representation of the detected edges in the field of view, means for forming the difference between the number of pixels constituting the representation and a reference value, means for detecting whether the difference exceeds a given value, and means for controlling the door, or access, in dependence on the detection result. The reference value may be a previously-determined pixel number, or the average of n previously-determined pixel numbers, preferably a weighted average, n being an integer greater than 1.

Advantageously, the system comprises means for dividing the field of view into a plurality of zones, said forming means being arranged to form a said difference for each respective zone and said detection means being arranged to produce a said detection result for each zone. The zones may be arranged at increasing distances from a reference datum, and each zone may be associated with a respective said reference value. The system may comprise means for selectively varying the or each reference value.

The system preferably comprises means for detecting temporal variations in the detected edges of the object. The system may comprise means for determining a value indicative of the distance of the “centre of mass” of said detected edges from a reference datum in said field of view, and means for detecting temporal variations of said distance-indicative values as indicative of changes within the field of view. The determining means may be arranged to determine said distance-indicative value by summing moments of the detected edges about the reference datum, and dividing the sum by the number of summed edges.

The detection means may be arranged to provide an output to door, or access, control means in dependence on whether the temporal variations indicate that the distance-indicative value becomes smaller.

Preferably, the system comprises means for determining a direction of motion of an object from the detected variations, and means for controlling the door, or access, in dependence on the determined direction of motion. The determining means may be arranged to perform a linear regression on the distance-indicative values to produce data indicative of the direction of motion of an object. The determining means may be arranged to perform an integration of said data, said control means being arranged to control the door, or access, depending on the result of the integration.

In a related aspect the present invention provides a method of controlling a door, or access to a particular area comprising

detecting an object by detecting a rising or falling edge in an analogue video signal as indicative of an edge of the object in a field of view; and

controlling the door, or access to the area, in dependence on the detection result.

The present invention further provides a method of controlling a door, or access to a particular area, comprising

obtaining a representation of a field of view;

determining the proportion of elements constituting the representation which satisfy a first criterion;

forming the difference between that proportion and a reference value;

detecting whether the difference exceeds a given threshold or not; and

controlling the door, or access to the area, in dependence on the detection result.

The present invention further provides a method of determining a direction of movement of an object, comprising

obtaining a representation of said object;

determining a value indicative of the distance of the “centre of mass” of those elements of the representation satisfying a first criterion, from a reference datum;

detecting temporal variations of said distance-indicating value as indicative of changes within the field of view; and

determining a direction of movement of the object from the detected variations.

The present invention further provides a method of controlling a door, or access to a particular area, comprising

obtaining a representation of a field of view divided into a plurality of zones;

for each zone, determining the proportion of elements constituting the representations which satisfy a first criterion;

for each zone, forming the difference between the proportion and at least one previously-determined proportion, preferably an average of n previously-determined proportions, more preferably a weighted average, wherein n is an integer greater than 1, to produce a differential proportion;

determining a value indicative of the distance of the “centre of mass” of the differential proportion from a reference datum, based on the distance of the respective zone from the reference datum;

detecting temporal variations of said distance-indicating value as indicative of changes within the field of view; and

controlling the door, or access to the area, in dependence on the detected variations.

Subsidiary features are as set out in the dependent claims. Method features equivalent to apparatus features disclosed herein are also provided and vice versa.

Preferred features of the present invention will now be described, by way of example only, with reference to the accompanying drawings, in which:

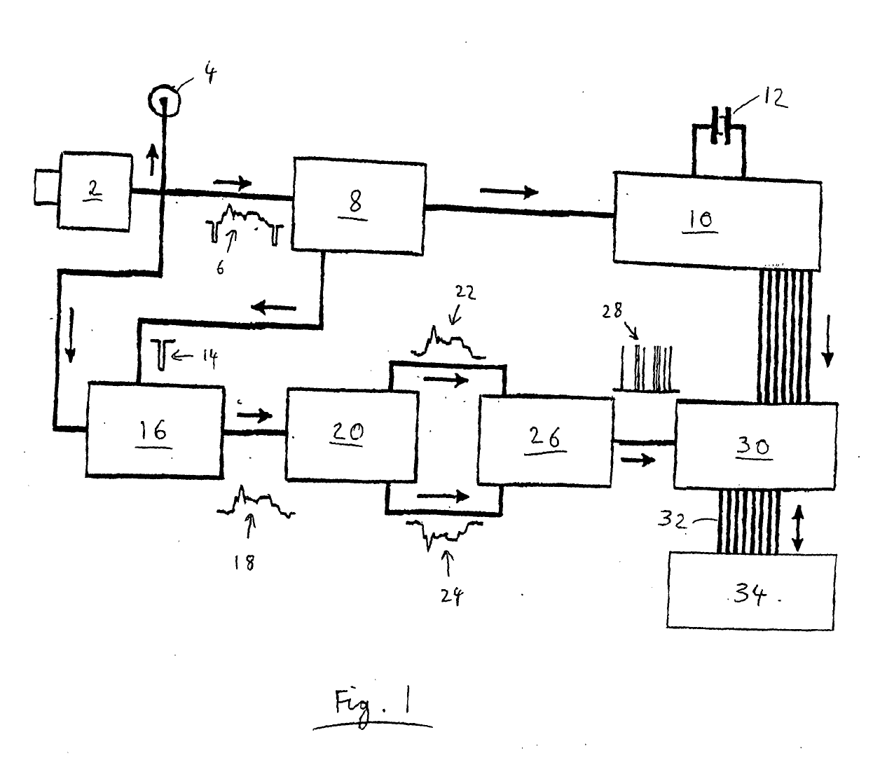

FIG. 1 shows a block diagram of a detection system used in the present invention;

FIG. 2 shows a first embodiment of a control system according to the present invention;

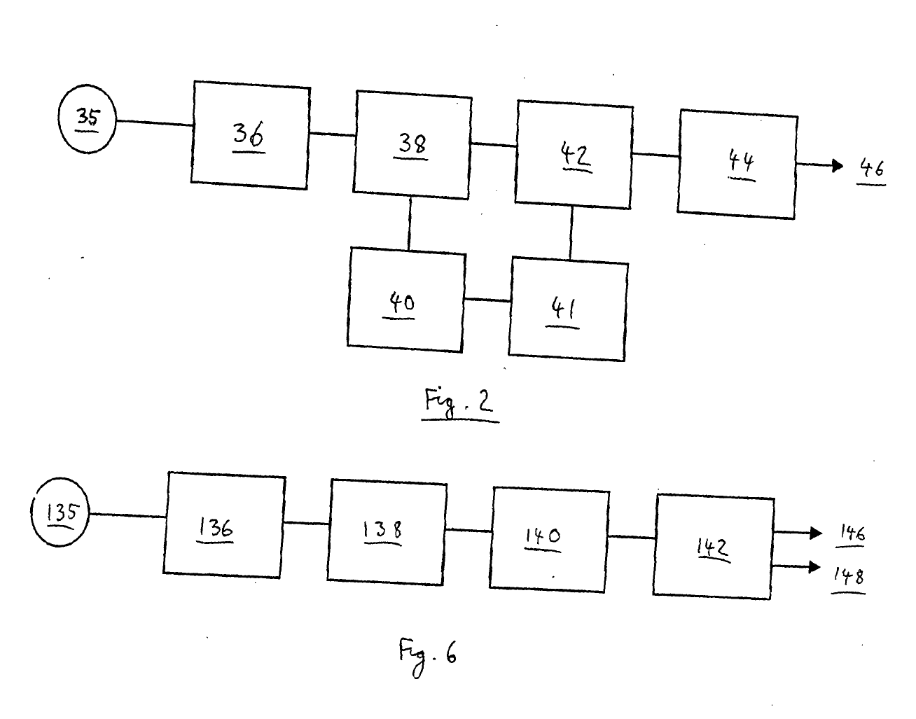

FIG. 3 shows an arrangement of several detection zones in front of a doorway;

FIG. 4 shows a representation of detection data for illustrating the function of a further embodiment of a control system according to the present invention;

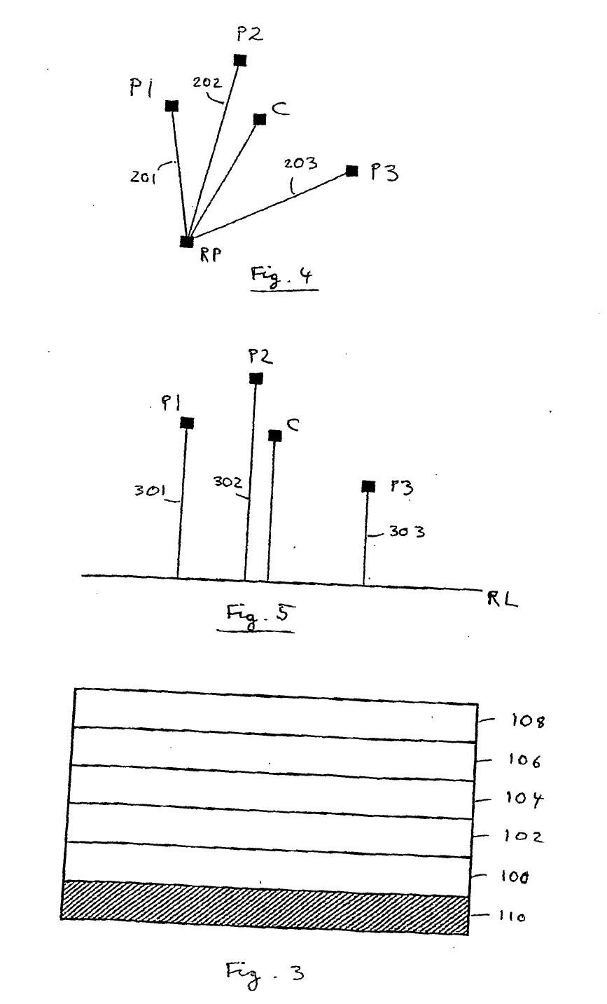

FIG. 5 shows a modification of FIG. 4; and

FIG. 6 shows a second embodiment of a control system according to the present invention,

Before embodiments of the invention proper are described, some background information of edge detection using a digital video signal is given.

The output from a video camera is a continuous stream of high-speed data, which is periodically interrupted by synchronisation pulses that define the start of an image “field” and the start of each line in that field. The signal between the pulses is a complex analog presentation of the brightness values along the scan line in question, and this is the information that is used to re-create the picture.

Because of the complex and fast nature of the video signal, it is usual to convert it to an array of numerical brightness values in a digital memory, before attempting to analyse it with a microprocessor. The required memory capacity is often relatively large, in particular if the memory needs to hold several images simultaneously. Further, in such a digital system an analog to digital converter is also required.

Once the images are stored in digital form, they can be analysed. Algorithms are known for sensing the “edges” present in an image. Edge detection allows the processor to greatly reduce the amount of data to be analysed, as the 8 bit “Grey Scale” image is reduced to a 1 bit black or white contour pattern. The image is now mostly black, with white lines surrounding individual objects. Edge detection is usually performed in software by passing a “Laplacian” operator over the image, a process that emphasises transient changes (edges) while suppressing slowly changing video data. However, the application of the Laplacian operator involves substantial computing power and time, leading to the need for a fairly powerful processor with its associated extra costs.

Further processing involves the detection of changes in the outline position, or comparison with previously recorded versions of the image field to detect changes from a reference image etc. Examples of such further processing are described below.

Referring now to FIG. 1, which shows a block diagram of an embodiment according to the present invention, a standard video camera 2 (for example a “CIF” format CMOS camera with a wide angle tens) feeds its output composite video signal 6 into a synchronisation pulse separator 8 and a synchronisation pulse removing circuit 16. The synchronisation separator 8 extracts the synchronisation pulses 14 from the video signal and these are used to provide timing information to a pixel counter and image memory 10.

The synchronisation pulses 14 extracted by synchronisation separator 8 are also provided to the synchronisation pulse removing circuit 16. The synchronisation pulse removing circuit 16 “slices off” the synchronisation pulses from the video so as to provide a video waveform 18 without synchronisation pulses. This processed signal is provided to a buffer and phase splitter circuit 20. The phase splitter 20 provides direct 22 and inverted 24 versions of the processed signal 18, which are then processed by two halves of a “dual differentiator” 26. The differentiator 26 consists of a pair of high-speed transient detectors, both of which detect positive going transients. However, as one of the input signals 24 to the differentiator circuit 26 is an inverted version of processed signal 18, effectively one half of the dual differentiator circuit 26 detects positive going transients, whereas the other detects negative going transients of processed signal 18. The transients are processed to become logic level pulses, capable of being stored as “0” or “1” in a 1 bit wide digital memory. The transients occur wherever the video information represents a sudden change of image brightness, such as at the edges of an object or person with contrast against their surroundings.

The resulting stream of pulses 28 is still at video speed and synchronised with the original image, so it may be combined with the synchronisation pulses and displayed on a TV monitor, if required, for example for set-up purposes. The pulse stream 28 can also be stored in the memory device, the location for each data bit being defined by the crystal controlled (12) Pixel counter 10, which is itself locked to the camera synchronisation pulses.

Once in memory, an external processor for object detection may access the stored data at high speed, as only 1 bit per pixel (rather than 8 bits, as with a digital system) is used.

If desired, the video signal 6 output by camera 2 can also be provided to a monitor via connector 4 . It may also be desirable to view the camera output signal 6 and a visual representation of the pulse stream 28 simultaneously, preferably superimposed on the same screen. If the detection system is configured such that a detection threshold can be adjusted it is thus possible to vary this detection threshold whilst simultaneously monitoring the result of the object detection with reference to the image as viewed by camera 2.

The stream of synchronisation pulses 14 may be used to determine that the camera 2 is operating correctly Any detected loss of the pulses can be used to trigger door opening until the stream of pulses has been restored. The video edge count may also be summed so as to trigger door opening if the summation drops below a preset threshold. This can enable situations such as lens obstruction and the onset of darkness to be handled; the use of a separate light sensor, such as a light dependant resistor, is optional for detecting low lighting. A system can be arranged such that a power loss can also trigger door opening, for example, the system may be operated via an AC processor output, via a capacitively coupled rectifier, so that a loss of processor function will cause relays to fall into a “door open” state.

In comparison to a digital system, which may use as many as 40 cores for the interconnection between the camera and a processor, according to the present invention the interconnection between camera 2 and processor 34 can be constituted by a coaxial lead. Further, this co-axial lead can be of almost any length, up to hundreds of metres if necessary.

Two examples of image storage and analysis techniques will now be explained with reference to FIGS. 2 and 3. As mentioned above, the raw data used in these techniques can be obtained in various ways and can (but does not have to) be obtained by means of the edge detection described above.

The input data 35 (representing e.g. edges of objects) is in a numerical format. It is therefore possible to sum bands and columns of pixels in real time and download the totals directly to processor 34. Totalisation may be performed within a shift register, or directly within the processor 34 itself.

The absolute white pixel count (e.g. corresponding to detected edges) in various image zones can be used as an indicator of the presence of new objects. In a crude system there would be only one zone, i.e. the entire field of view. However, more precise results may be obtained if the field of view is split into several zones. These are advantageously arranged at increasing distances from the doorway.

The background count due to paving, plants, litter etc. will be essentially constant for short periods and the entry of a person into a zone will cause a large change in this count. The white pixel count can simply be compared with a reference value, for example a predetermined, fixed value. If the difference between the white pixel count and the reference value exceeds a threshold a positive detection result is given. This threshold can be set sufficiently high to avoid “false triggers” due to changes in lighting etc., but low enough to trigger reliably on large objects, such as people. However, this simple option may lead to a situation in which the detection threshold cannot cope with major scene changes and is relatively insensitive to small targets, such as children.

In a preferred embodiment the system is “adaptive” to the scene, with a time constant appropriate to the speed of persons passing through the sensitive zones. This function may be performed by storing the mean signal value of each zone in a memory array and then subtracting it from the signal being received. If no change has occurred, the result of this subtraction will be very close to zero, but will rapidly increase if a new object enters the zone. To cope with slow changes within the scene, the error signal may be used to incrementally adjust the values stored in the memory array, according to a software timer. This will gradually remove any permanent error signal and so compensate for changes of lighting, weather conditions, or physical debris etc. The time interval required is usually adjusted to correct for a major change within about 60 seconds, which allows ample time for slowly moving persons to leave the sensitive zone before the trigger signal is cancelled by the adaption process.

In another embodiment two “adaption modes” may be provided. When a detection signal is present (that is, a signal of sufficient magnitude that the preset threshold is exceeded) the system operates in a “slow adaption mode” and will not cancel the trigger signal (to close the door) until the detected object leaves the field of view or a predetermined time (up to several minutes) have elapsed, as determined by an internal timer However, where no detection signal is present and the system remains “untriggered”, it operates in a “fast adaption mode” where moderately slow changes in the video signal are compensated for before they are sufficient to cause a trigger signal. Moderately fast lighting changes are therefore ignored, but the entrance of a person into the field of view is still a sufficiently rapid and large change to cause a trigger and a consequent shift to the slow adaption mode.

Although operation in a fast adaption mode is effective at suppressing moderately fast lighting changes in the field of view, it cannot cope well with almost instantaneous lighting changes, such as those occurring when fast moving shower clouds suddenly mask the sun or, equally rapidly, re-expose it to view. In order to accommodate for such conditions, a second parameter is used to vary the threshold according to the overall “unadapted” detail in the picture; whilst a person occupies only a portion of the field of view, ambient lighting changes tend to affect the entire field of view. There is thus a “common mode” signal associated with environmental changes which represents the uncompensated signal which remains before the “fast adaption” has time to correct for the variation in the lighting. By adding a portion of the common mode signal to the threshold, the sensitivity of the system can be altered in proportion to the rapid lighting changes, thus reducing the tendency for false triggers.

An additional function is to reduce the sensitivity of the system in the few seconds immediately following a trigger. This can reduce the tendency for the shadow of the door styles to cause a false trigger as they move together during closure, typically approximately two seconds after the trigger has been cancelled; if the sun, or strong artificial light, is shining through the door moving shadows will be seen in the field of view which can cause unwanted re-opening or even oscillation of the door opening mechanism. By increasing the proportion of the common mode signal added to the threshold during the door closure time, such false triggers can be suppressed. However, as the sensitivity to the entry of a person into the field of view would be somewhat reduced by this, this function is preferably provided as a switchable option for when strong lighting causes a serious problem.

An embodiment of a static object detection system is illustrated in FIG. 2.

Data 35 identifying the position of edges of objects in the field of view is stored in memory 36. A pixel counter 38 counts the number of white pixels (corresponding to edges) of data stored in memory 36 for each zone. Several zones may be arranged as shown in FIG. 3, where five zones 100, 102, 104, 106 and 108 are arranged in front of doorway 110, at increasing distances. The pixel count from pixel counter 38 is stored in a further memory 40 which contains not only the most recent pixel count but additionally one or more previous pixel counts for each zone. Subtracter 42 forms the difference between the most recent pixel count and, in one embodiment, one previous pixel count stored in memory 40. Comparator 44 compares this difference with a threshold. If the difference exceeds the threshold a positive detection result is given at output 46.

The system can be made more adaptive if, for the purpose of forming the difference in pixel count at subtracter 42 not only one previous pixel count stored in memory 40 is taken into account, but several previous pixel counts. This can be achieved by means of averager 41, which takes an average of n previous pixel counts (n being an integer greater than 1). In certain situations it may be desirable for averager 41 to form a weighted average, for example by giving greater weight to more recent pixel counts than to earlier ones.

Motion detection, with no direction sensitivity, can be performed by subtracting the previous image frame from the latest image frame and examining the result. Any significant motion will result in imperfect subtraction of the frames and leave a residual signal, which can be sensed and used to generate a trigger. This form of motion sensing can be useful for a door control system, but does not permit the device to determine the motion vector of the moving object. It would be desirable to make a judgement about the intentions of, for example, a potential customer and open the doors only if there is a likelihood that he intends to enter.

It will be appreciated that the average person varies in apparent shape as he walks and determining an accurate vector is complicated by this effect. To avoid this problem the “centre of mass” of the image is determined and its location over time is followed. The process involves “taking moments” about a fixed point, line or surface in the image ( typically the door surface) for all of the white pixels in the image, which provides a set of coordinates for the centre of mass of the white data. The “y” coordinate (e.g. distance perpendicular to the door) is then stored in the first element of an array, the other elements of which contain the coordinates for previous frames, e.g. the last 10 frames. The insertion of the new element causes the others to move up by one position and the 10^{th} one to be ejected from the array. As time passes, the values step along the array until they are “lost” from the end, and this provides a “moving picture” of the centre of mass location for a time period of 10 frames. To determine the motion vector in a useful form, a “linear regression” may be performed on the array contents and this gives the gradient of the “best fit” straight line for the array data. The slope and polarity of the gradient provide the motion vector information in a form in which slope is equivalent to velocity and polarity is equivalent to the direction to, or from, the door.

An embodiment of a motion detection system is illustrated in FIG. 6. Data 135 identifying the position of edges of objects in the field of view is stored in memory 136. Simplified representations of examples of input data 135 are shown in FIGS. 4 and 5. The detected edges are represented by only three points P1, P2 and P3, although it will be appreciated that a detected edge will normally consist of several adjacent pixels. However, for ease of illustration only three pixels are shown. Referring first to FIG. 4, this figure also shows a reference point RP, which may, for example, be located at the centre of the base line of a doorway. Lines 201, 202 and 203 are representative of the moments of the pixels P1, P2 and P3 about reference point RP. These moments are processed in a further processor 138, which determines the centre of mass C of pixels P1, P2 and P3. The coordinates of the centre of mass are stored in a further memory 140, for several successive moments in time. Processing unit 142 analyses the coordinates of these centres of mass to determine any movement of the centre of mass between successive images. This can be done simply by subtracting the coordinates of the centre of mass at one instant from the coordinates of the centre of mass in a previous instant, and this difference will be representative of a motion vector of the centre of mass. The component of this motion vector in the direction of reference point RP can then be extracted, and its length (corresponding to speed of the centre of mass to or from reference point RP) can be provided at output 146 and its polarity (indicating whether the centre of mass moves towards or away from reference point RP) can be provided at output 148. The door or access control system can then perform its control function in dependence on the outputs 146 and 148, e.g. by opening the door if output 146 is sufficiently high and output 148 indicates that the centre of mass moves towards the reference point RP.

Instead of a simple vector subtracter 142 more sophisticated processing devices can be provided which perform, for example, a linear regression of the coordinates of the centres of mass stored in respect of several successive frames in memory 140. Again, a motion vector can be derived from the linear regression and its length and polarity be provided at outputs 146 and 148.

A further embodiment will now be described with particular reference to FIG. 5. The same representative pixels P1, P2 and P3 are shown. However, instead of a reference point RP a reference line RL is shown, which may, for example, correspond to the base line of a door. Now only the distances of the pixels from the reference line RL as indicated by lines 301, 302, and 303 is of interest. These distances are stored in memory 136, and processor 138 now calculates the distance of the centre of mass C from the reference line RL. This can be done simply by averaging the distances 301, 302 and 303. Again, the distance of the centre of mass is stored in memory 140 for several frames, and temporal variations in that distance are analysed by processing unit 142, providing the magnitude of these variations at output 146 and the polarity at output 148. Again, processing unit 142 can be a simple subtracter, or may be more sophisticated devices performing a linear regression.

Although not specifically illustrated, the technique can be modified so that the distance of pixels P1, P2 and P3 from a reference surface (e.g. a door surface) is taken into account, rather than from a reference point or line.

As discussed above, the centre of mass refers to the position at which, from the detected edges of the overall image, the image appears to be centred. In a simple case, where a single object is present in the centre of the field of view, the position of the centre of mass will coincide with the object. A complex image is treated as a system of masses with moments taken about a reference datum. In all cases, taking moments for each of the detected edges in different bands and combining them will provide a centre of mass (centroid) for the image. Successive centroid positions are plotted as a continuously updated flow of data, the effective gradient of which can be determined by performing a linear regression on the co-ordinates of the centroids in the previous, say, 10 successive frames. If the positions are plotted in such a way that the greatest centroid location value (in zone 100) is at the door surface and the least value (in zone 108) is at the far edge of the field of view, the gradient will be positive for an approaching object.

With this method, whilst an object entering the field of view at zone 108 and moving towards the door would cause a correct trigger, if, for example, an object crossed the field of view roughly parallel with the door, entering the field of view at zone 100 or 102, this would cause a sudden jump in the gradient from near zero to some large positive number. This would cause the door to open, even though no approach has actually occurred.

To overcome this, a second integration of the gradient data is performed and the results stored as a variable referred to as the “gradient trend (GT)”. When no objects are moving in the field of view, the GT is approximately zero. As movement is detected, the GT begins to increase. If the gradient remains positive, by virtue of a person approaching the door, then the GT rapidly increases to exceed a preset GT trigger value and cause the door to open. If a person enters the field of view and moves parallel to the door, the gradient is initially strongly positive but rapidly falls to near zero as no further approach is detected. As a result, the GT climbs briefly but soon becomes static and so does not exceed the GT trigger value, as movement away from the door results in a negative gradient. A negative offset may be added to the GT, the value of the offset increasing with the proximity of the detected person to the door, in order to reduce further the likelihood of a false trigger. By making the GT trigger value inversely proportional to the number of detected edges, false triggers due to distant passers-by can be suppressed. A distant person produces relatively few detected edges, and so the GT trigger value for a number of distant persons would be higher than for the same number of proximate persons, and so more difficult to exceed.

While the present invention has been described in its preferred embodiments, it is to be understood that the words which have been used are words of description rather than limitation and that changes may be made to the invention without departing from its scope as defined by the appended claims.

Each feature disclosed in this specification (which term includes the claims) and/or shown in the drawings may be incorporated in the invention independently of other disclosed and/or illustrated features.

### DESCRIPTION OF REFERENCE NUMERALS

2 Camera

4 Video to monitor

6 Analogue video signal including synchronisation pulses

8 Synchronisation pulse separator

10 Pixel counter

12 Crystal controller

14 Synchronisation pulse

16 Synchronisation pulse remover

18 Processed video signal without synchronisation pulses

20 Buffer/phase splitter

22 Non-inverted processed video signal without synchronisation pulses

24 Inverted processed video signal without synchronisation pulses

26 Dual differentiator

28 Pulse train (edge signal)

30 1 bit wide Image Memory

32 Data bus

34 Processor

1-63. (canceled)

64. A door or access control system including an object detector for detecting a rising and/or falling edge in an analogue video signal as indicative of an edge of an object in a field of view.

65. A system according to claim 64, wherein the detector comprises a differentiator for differentiating the analogue video signal to detect the rising and/or falling edge.

66. A system according to claim 64, comprising a camera for providing the analogue video signal to the detector, and wherein the video signal provided by the camera includes synchronisation pulses, the system comprising a circuit for removing the synchronisation pulses from the analogue video signal and passing the thus processed signal to the detector.

67. A system according to claim 64, comprising a display for displaying a visual representation of the detected rising or falling edge superimposed on a visual representation of the analogue video signal.

68. A system according to claim 64, comprising a store for storing a representation of the detected edges of the object.

69. A system according to claim 64, comprising a processor for obtaining a pixel representation of the detected edges in the field of view, for forming the difference between the number of pixels constituting the representation and a reference value, and for detecting whether the difference exceeds a given value, and a controller for controlling the door, or access, in dependence on the detection result.

70. A system according to claim 69, wherein the reference value is the average of n previously-determined pixel numbers, preferably a weighted average, n being an integer greater than 1.

71. A system according to claim 69, wherein the processor is configured to divide the field of view into a plurality of zones, to form a said difference for each respective zone and to produce a said detection result for each zone.

72. A system according to claim 64, wherein the processor is configured to detect temporal variations in the detected edges of the object.

73. A system according to claim 72, wherein the processor is configured for determining a value indicative of the distance of the “centre of mass” of said detected edges from a reference datum in said field of view, for detecting temporal variations of said distance-indicative values as indicative of changes within the field of view.

74. A system according to claim 73, wherein the processor is configured for determining a direction of motion of an object from the detected variations, the system comprising a controller for controlling the door, or access, in dependence on the determined direction of motion.

75. A system according to claim 74, wherein the processor is configured to perform a linear regression on the distance-indicative values to produce data indicative of the direction of motion of an object, and to perform an integration of said data, said controller being arranged to control the door, or access, depending on the result of the integration.

76. A method of controlling a door, or access to a particular area, comprising:
detecting the presence of an object in a field of view by detecting a rising and/or falling edge in an analogue video signal as indicative of an edge of the object; and
controlling the door, or access to the area, in dependence on the detection result.

77. A method according to claim 76, wherein the rising and/or falling edge is detected by differentiating the analogue video signal.

78. A method according to claim 76, wherein a visual representation of the detected edges is displayed superimposed on a visual representation of the analogue video signal.

79. A method according to claim 78, comprising the steps of obtaining a pixel representation of the detected edges in the field of view, forming the difference between the number of pixels constituting the representation and a reference value, detecting whether the difference exceeds a given value, and controlling the door, or area access, in dependence on the detection result.

80. A method according to claim 79, wherein the reference value is the average of n previously-determined pixel numbers, preferably a weighted average, n being an integer greater than 1.

81. A method according to claim 79, wherein the field of view is divided into a plurality of zones, the forming and detection steps being conducted for each zone to produce a corresponding plurality of detection results.

82. A method according to claim 76, comprising detecting temporal variations in the detected edges of the object.

83. A method according to claim 82, comprising determining a value indicative of the distance of the “centre of mass” of said detected edges from a reference datum in said field of view, and detecting temporal variations of said distance-indicative values as indicative of changes within the field of view, wherein the distance-indicative value is determined by summing moments of the detected edges about the reference datum, and dividing the sum by the number of summed edges.

84. A method according to claim 83, wherein a direction of motion of an object is determined from the detected variations, and the door, or area access, controlled in dependence on the determined direction of motion.

85. A method according to claim 84, wherein a linear regression is performed on the distance-indicative values to produce data indicative of the direction of motion of an object, and wherein an integration of said data is performed, the door, or area access, being controlled in dependence on the result of the integration.

86. A method of controlling a door, or access to a particular area, comprising:
obtaining a representation of a field of view;
determining the proportion of elements constituting the representation which satisfy a first criterion;
forming the difference between that proportion and a reference value;
detecting whether the difference exceeds a given threshold or not; and
controlling the door, or access to the area, in dependence on the detection result.

87. A method according to claim 86, wherein the representation is a pixel representation of edges of one or more objects or portions of one or more objects in the field of view.

88. A method according to claim 86, wherein the reference value is the average of n previously-determined proportions, preferably a weighted average, n being an integer greater than 1.

89. A method according to claim 86, wherein the difference is formed between the proportion and a previously-determined proportion, preferably the average of n previously-determined proportions, more preferably a weighted average (n being an integer greater than 1), to produce a differential proportion.

90. A method of determining a direction of movement of an object, comprising:
obtaining a representation of said object;
determining a value indicative of the distance of the “centre of mass” of those elements of the representation satisfying a first criterion, from a reference datum;
detecting temporal variations of said distance-indicating value as indicative of changes within the field of view; and
determining a direction of movement of the object from the detected variations.

91. A method according to claim 90, wherein the value indicative of the distance of the “centre of mass” is determined by: summing moments of the elements satisfying the first criterion, about the reference datum; and
dividing the sum by the number of summed elements.

92. A method according to claim 90, wherein an output is provided in dependence on whether the temporal variations indicate that the distance of the “centre of mass” becomes smaller.

93. A method according to claim 90, wherein an output is provided in dependence on the magnitude of the temporal variations.

94. A method of controlling a door, or access to a particular area, comprising:
carrying out the method of claim 90; and
controlling the door, or access to the area, in dependence on the direction of the movement of the object.

95. A method according to claim 94, wherein the reference datum is a point, straight line or surface forming part of the door, or of a surface delimiting a particular area.
